(19) United States
(12) Patent Application Publication
(10) Pub. No.: US 2011/0229780 A1
(43) Pub. Date: Sep. 22, 2011

(54) HYDROGEN GENERATION AND STORAGE SYSTEM FOR COLLECTION AND STORAGE OF ENERGY

(76) Inventor: Dan Kershaw, Mesquite, NV (US)

(21) Appl. No.: 13/007,486

(22) Filed: Jan. 14, 2011

Related U.S. Application Data
(63) Continuation-in-part of application No. 12/728,923, filed on Mar. 22, 2010.

(51) Int. Cl. H01M 8/06; C25B 9/00; C25B 15/02; C25B 1/02

(52) U.S. Cl. 429/422; 204/230.2; 204/228.1; 204/228.3; 205/343

(57) ABSTRACT

A hydrogen generation and storage system provides energy storage and energy production through use of hydrogen. The system may comprise a hydrogen generation subsystem and a storage subsystem. Typically, the system will be powered by a renewable or environmentally friendly electrical source, such as wind, solar, geothermal, hydroelectric, or wave energy. The stored hydrogen may automatically be used to supplement electrical output, such as to meet demand for electricity.

### CROSS-REFERENCE TO RELATED APPLICATION

This application is a continuation-in-part of U.S. patent application Ser. No. 12/728,923, titled Thermoelectric Collection and Storage of Solar Energy, filed Mar. 22, 2010.

### BACKGROUND OF THE INVENTION

1. Field of the Invention

The invention relates generally to the collection of solar energy and in particular to a method and apparatus for thermoelectric collection and storage of solar energy.

2. Related Art

Solar energy, while abundant and clean, has the drawback of being difficult to convert into usable energy such as electricity. For example, photovoltaic cells have been used to convert solar energy into electricity. Photovoltaic cells must be kept clean however, and are relatively inefficient. Solar energy may also be converted into electricity by utilizing its heat to power steam generators. This utilizes multiple conversions, from solar heat energy to mechanical energy and then to electricity. At each conversion point some energy is lost, reducing the efficiency of the overall system.

Solar energy may also be converted into electricity by the thermoelectric effect. Typically however, the thermoelectric effect generates small amounts of electricity, and is most often used to measure temperature, and not to generate electricity for use. The thermoelectric effect has been used to generate electricity from heat however, the heat source is generally a mechanical device or machinery which operates at very high temperatures. For example, it has been proposed that automobile exhaust heat be used to generate electricity to at least partially power a vehicle through the thermoelectric effect. This application of the thermoelectric effect relies upon a mechanical heat source which is not as abundant and clean as solar heat energy. In addition, the application of the thermoelectric effect in this manner typically generates little usable electricity.

From the discussion that follows, it will become apparent that the present invention addresses the deficiencies associated with the conversion of solar heat energy to electricity with the thermoelectric effect while providing numerous additional advantages and benefits not contemplated or possible with prior art constructions.

### SUMMARY OF THE INVENTION

A hydrogen generation and storage system is disclosed herein. The system may be used to generate hydrogen and store the hydrogen. In one or more embodiments, the stored hydrogen may be consumed, such as by burning or oxidizing the hydrogen, at a later time. In this manner, energy may be stored in the form of hydrogen for later use. Alternatively, the hydrogen may be consumed directly as a clean fuel.

The hydrogen generation and storage system may have a variety of configurations. For example, in one embodiment, the system may comprise one or more electrical power sources configured to generate electrical power from a renewable energy source (such as from wind, solar, wave, hydroelectric, and geothermal energy). An electrolysis tank having a diaphragm that divides the electrolysis tank into a first section and a second section may be included. At least one positive electrode may be in the first section, and at least one negative electrode may be in the second section.

At least one first conduit may extend from an upper portion of the first section to accept oxygen gas from the first section, and at least one second conduit may extend from an upper portion of the second section to accept hydrogen gas from the second section. One or more storage tanks configured to releasably store the hydrogen gas and oxygen gas may be connected to the first conduit and the second conduit.

It is noted that the storage tanks comprise a first compartment for storing oxygen and a second compartment for storing hydrogen, the first compartment connected to the first conduit and the second compartment connected to the second conduit. The storage tanks may be portable and removable from the first conduit and the second conduit.

One or more controllers may be included as well. The controllers may be configured to route electrical power from the electrical power sources to the positive electrode and the negative electrode when the amount of electrical power generated by the electrical power sources exceeds the amount of electrical power that is demanded from the electrical power sources.

The controllers may be further configured to release hydrogen gas from the storage tanks when the amount of electrical power generated by the electrical power sources is less than the amount of electrical power that is being demanded from the electrical power sources.

It is noted that at least one of the electrical power sources includes a fuel cell generator configured to generate electricity from hydrogen gas. The fuel cell generator may be connected to at least one of the storage tanks by at least one third conduit. In addition or alternatively, a hydrogen powered steam turbine configured to generate electricity from burning hydrogen gas may be connected to at least one of the storage tanks by at least one third conduit.

At least one valve configured to control the flow rate of the oxygen gas relative to the hydrogen gas from the electrolysis chamber to the storage tanks may connect the storage tanks to the electrolysis chamber.

In another exemplary embodiment, the system may comprise an electrical power source configured to generate a first amount of electrical power to meet at least some of a demand for a second amount of electrical power, one or more electrolysis chambers (configured to generate hydrogen gas and oxygen gas from water) comprising at least one positive electrode and at least one negative electrode, and one or more electrical conduits connecting the electrical power source to the positive electrode and the negative electrode.

One or more storage tanks configured to store the hydrogen gas and oxygen gas from the electrolysis chambers may be connected to the electrolysis chambers by one or more conduits. At least one of the storage tanks may be configured to store hydrogen, and at least another of the storage tanks may be configured to store oxygen. It is noted that some storage tanks may comprise an outlet port configured to control outflow of the oxygen gas relative to the hydrogen gas to generate a predetermined ratio of hydrogen gas and oxygen gas. One or more compressors configured to compress the hydrogen gas and the oxygen gas in the storage tanks may be included as well.

At least one controller may also be included in the system. The controller may be configured to configured to divert electrical power from the electrical power source to the positive electrode and the negative electrode when the first amount of power is greater than the second amount of power, and to release hydrogen gas from the storage tanks when the first amount of power is less than the second amount of power.

It is noted that a hydrogen powered electrical generator configured to accept hydrogen gas from the storage tanks and to oxidize the hydrogen gas to generate electricity may also be provided.

At least one valve may connect the storage tanks to the electrolysis chambers. The valve may be configured to control the flow rate of the oxygen gas relative to the hydrogen gas from the electrolysis chambers to the storage tanks.

In another exemplary embodiment, a method for generating and storing energy with hydrogen is provided. The method may comprise generating a first amount of electrical power with a first generator to meet at least some of a demand for a second amount of electrical power, routing at least some of the first amount of electrical power to an electrolysis chamber if the first amount of electrical power excess the second amount of electrical power, storing hydrogen generated by the electrolysis chamber in one or more hydrogen storage tanks, and releasing at least some of the hydrogen from the hydrogen storage tanks if the first amount of electrical power is less than the second amount of electrical power.

A third amount of electrical power may be generated with a second generator configured to convert the released hydrogen into electricity. The first amount of electricity and the third amount of electricity may then be transmitted to one or more consumers. All of the first amount of power may be transmitted to meet the demand for second amount of power if the first amount of power is less than the second amount of power.

It is noted that oxygen generated by the electrolysis chamber may be stored in one or more oxygen storage tanks. The stored oxygen and stored hydrogen may be mixed according to a predetermined ratio prior to generating the third amount of electrical power.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a block diagram illustrating an exemplary thermoelectric collector for storing energy as hydrogen;

FIG. 2A is a perspective view of an exemplary high density thermopile;

FIG. 2B is an exploded view of an exemplary high density thermopile;

FIG. 3 is a perspective view of an exemplary water cooled thermoelectric collector;

FIG. 4 is a top view of an exemplary quench ring for a thermoelectric collector;

FIG. 5 is a top view of an exemplary heat exchanger for a thermoelectric collector;

FIG. 6 is a perspective view of an exemplary air cooled thermoelectric collector;

FIG. 7 is a top view of an exemplary shaped high density thermopile; and

FIG. 8 is a perspective view of a portion of an exemplary solar collector formed with a high density thermopile;

FIG. 9 is a block diagram illustrating an exemplary hydrogen generation and storage system;

FIG. 10A is a front view of an exemplary storage tank;

FIG. 10B is a front view of an exemplary storage tank;

FIG. 10C is a front view of an exemplary storage tank;

FIG. 10D is a front view of an exemplary storage tank; and

FIG. 11 illustrates and exemplary hybrid power plant.

### DETAILED DESCRIPTION OF THE PREFERRED EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the thermoelectric collector herein converts solar heat energy into a storable form. The thermoelectric collector may utilize the thermoelectric effect, also known as the Peltier-Seebeck effect, to generate electricity directly with heat from the sun in one or more embodiments. As used herein, the term thermoelectric effect refers to the characteristic of dissimilar conductive materials, joined at an electrical junction, to generate electricity when a temperature difference or thermal gradient occurs along the conductive materials. As will be described below, the thermoelectric collector herein utilizes a novel high density thermopile to generate electricity from heat in one or more embodiments.

Electricity generated by the thermoelectric collector may be put to use or be stored for later use. This is highly advantageous because the energy generated by the thermoelectric collector comes from solar energy which is a non-polluting energy source and abundant. In addition, the thermoelectric collector allows solar energy to be used at night or when the sun is obscured by weather or other phenomena. This is because the thermoelectric collector may be configured to store the solar energy it collects so that the energy may be used when desired.

An exemplary thermoelectric collector will now be described with regard to FIG. 1. FIG. 1 is a block diagram illustrating various components of an exemplary thermoelectric collector 144. Of course, a thermoelectric collector 144 may comprise a subset of these components as well as components not illustrated by the exemplary embodiment.

As shown, the thermoelectric collector 144 comprises a solar concentrator 104 and thermoelectric generator 108. The solar concentrator 104 may be configured to gather solar energy and concentrate it to maximize its effects. For example, the solar concentrator 104 may be an optical device which focuses the sun's rays over a larger area onto a particular smaller area. In one embodiment, the solar concentrator 104 may be one or more lenses, a reflective parabolic dish or curved surface, or other reflective surface which focuses or concentrates the sun's rays onto a particular area. The concentrated energy may then be applied to the thermoelectric generator 108 to produce electricity.

In general, the thermoelectric generator 108 utilizes the thermoelectric effect to generate electricity from heat. In one or more embodiments, the thermoelectric generator 108 may comprise a heated end and a cooled end. The temperature gradient between these ends controls the amount of electricity that can be generated. Typically, the greater the difference in temperature between the heated end and the cooled end the more electricity can be generated.

The thermoelectric generator 108 herein, which will be described further below, has a novel configuration which is well suited for electricity generation with solar heat energy. In addition and as will be described further below, unlike traditional thermoelectric generators, such as thermocouples or thermopiles, the thermoelectric generator 108 herein has a configuration which itself assists in generating a temperature gradient from the heated end to the cooled end.

While the heated end of the thermoelectric generator 108 is heated by the solar concentrator 104, the cooled end may be cooled by a cooling mechanism 148. This allows the beneficial temperature gradient to be created. In general, the cooling mechanism 148 takes heat away from the cooled end of the thermoelectric generator 108 to cool the cool end. This may be accomplished in various ways, now known or later developed. For example, as shown, the cooling mechanism 148 comprises a heat exchanger 112 which transfers heat away from the cool end of the thermoelectric generator 108 and a heat dissipater 116 which dissipates the transferred heat, such as into the environment. To illustrate, the cooling mechanism 148 of this embodiment may transfer heat away from the thermoelectric generator 108 with a heat exchanger 112 and dissipate it through a heat dissipater 116 such as a cooling tower, geothermal heat sink, or the like.

Electricity generated from the thermoelectric generator 108 via the temperature gradient discussed above, may then be used for various purposes or stored for later use. For example, the electricity may be used to power one or more devices or may be stored by batteries or other energy storage devices. It is contemplated that at least some of the electricity may be used to power one or more components of the thermoelectric collector 144. For example, some electricity may be used to power the cooling mechanism 148 in one or more embodiments.

In the embodiment shown, the electricity is used to generate hydrogen. The hydrogen may then be stored for later use in generating energy. Of course, the hydrogen may also be used for other purposes. In this manner, the energy from the sun is collected and captured. The energy from the sun may then be used as desired even when solar energy is not directly available from the sun, such as at night or in bad weather.

As shown, the electricity from the thermoelectric generator 108 is used to power a positive electrode 136 and a negative electrode 132 within a water tank 152 holding a quantity of water. This causes the liquid dihydrogen oxide to be separated into hydrogen and oxygen is gaseous from in an electrolytic process. A diaphragm 156 may separate the water tank 152 into two chambers such that the hydrogen gas and oxygen gas released remains separated. The diaphragm 156 may be conductive and/or have one or more openings below the waterline in one or more embodiments. The hydrogen gas may then be collected from the water tank 152 through one or more conduits 140. The collected hydrogen gas may be stored in a hydrogen storage tank 124 for later use. It is noted that the hydrogen may also be compressed by a compressor 120 to allow a larger quantity of the gas to be stored within the storage tank. Likewise, as illustrated in FIG. 1, oxygen gas from the electrolytic process may also be captured in an oxygen storage tank 128 in a similar fashion. The storage tanks may be a variety of containers suitable for storing gas. This includes underground and aboveground storage containers.

It is contemplated that the hydrogen may be kept in the hydrogen storage tank 124 and may be used directly from the storage tank in one or more embodiments. Alternatively, or in addition, the hydrogen may be bottled or contained in one or more additional storage tanks which may be transported for use at other locations, or pumped through one or more pipes for use at other locations. Typically, the hydrogen gas will be “burned” to generate energy when desired. Of course, the hydrogen gas may be used for various other purposes requiring hydrogen gas.

As can be seen from the above, the thermoelectric collector 144 collects solar energy for use as electricity or for later storage while taking advantage of the cleanliness and abundance of solar energy. When used to generate electricity for direct or immediate use, the thermoelectric collector 144 provides the benefit of clean energy by converting non-polluting energy from the sun into usable electricity. When used to store solar energy, such as in the form of hydrogen, the thermoelectric collector 144 adds the benefit of allowing solar energy to be used at anytime regardless of whether or not the sun is available.

Typically, the thermoelectric collector 144 will be configured to collect and store solar energy in the form of hydrogen. For example, in some embodiments or circumstances (such as bad weather), the thermoelectric collector 144 may not generate sufficient electricity to be used directly, but may generate sufficient electricity to power electrolysis which, as stated, may be used to store solar energy as hydrogen.

It is contemplated that one or more thermoelectric collectors 144 may by installed in areas exposed to high solar energy or other locations to continuously generate hydrogen when solar energy is available. Though the quantity of hydrogen produced may be relatively small, over time, substantial amounts of hydrogen may be produced. Additional thermoelectric collectors 144 may be installed to increase hydrogen production. It will be understood that as many or as few thermoelectric collectors 144 may be installed to provide for the energy needs of surrounding or remote areas.

The thermoelectric collector 144 is highly advantageous to populations where access to electrical power is limited. For example, a population with limited access to electrical power may only desire hydrogen energy at night to power lighting or other electrical devices. Thus, even where the hydrogen generated is a relatively small quantity, this may be sufficient to supply the electrical needs for a given population. Of course, as stated, additional thermoelectric collectors 144 may be installed to meet higher demands for energy. Of course, the electricity, hydrogen, or both generated by the thermoelectric collector 144 may be used at other times as well.

It is also contemplated that thermoelectric collectors 144, and specifically the hydrogen generated form the collectors, may be used to supplement an existing energy source. This is advantageous in that it may reduce the reliance on energy sources known or thought to be damaging to the environment or unsustainable.

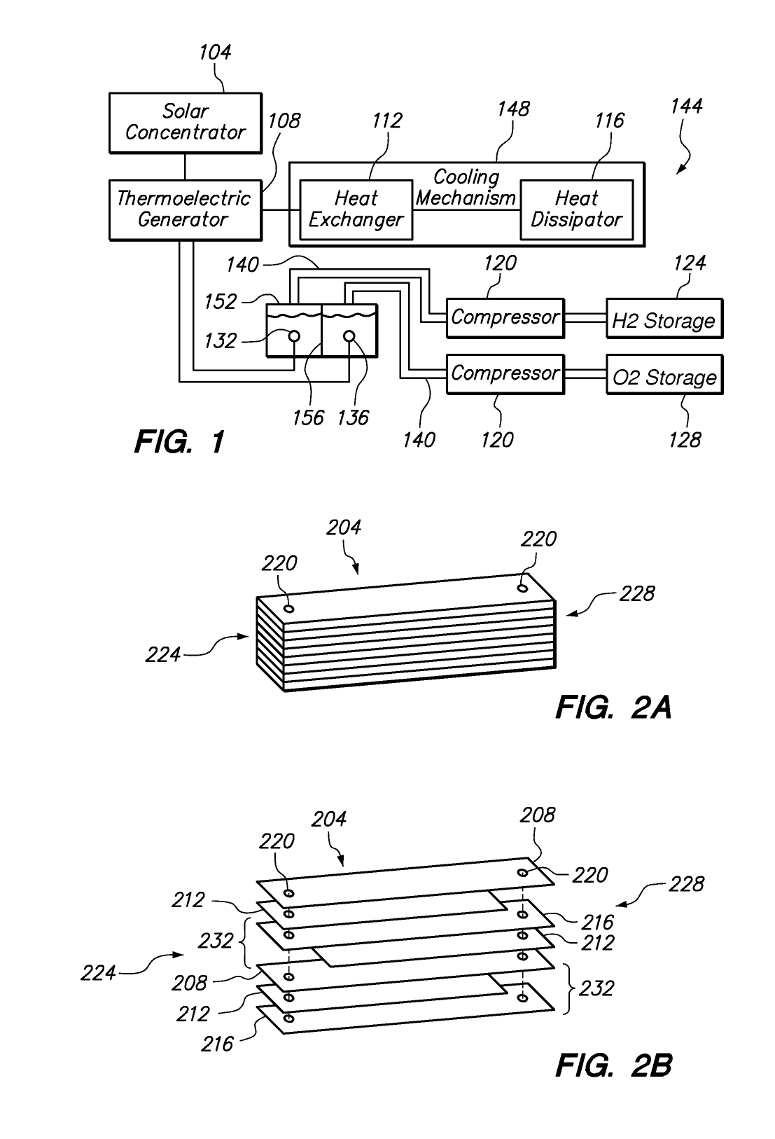

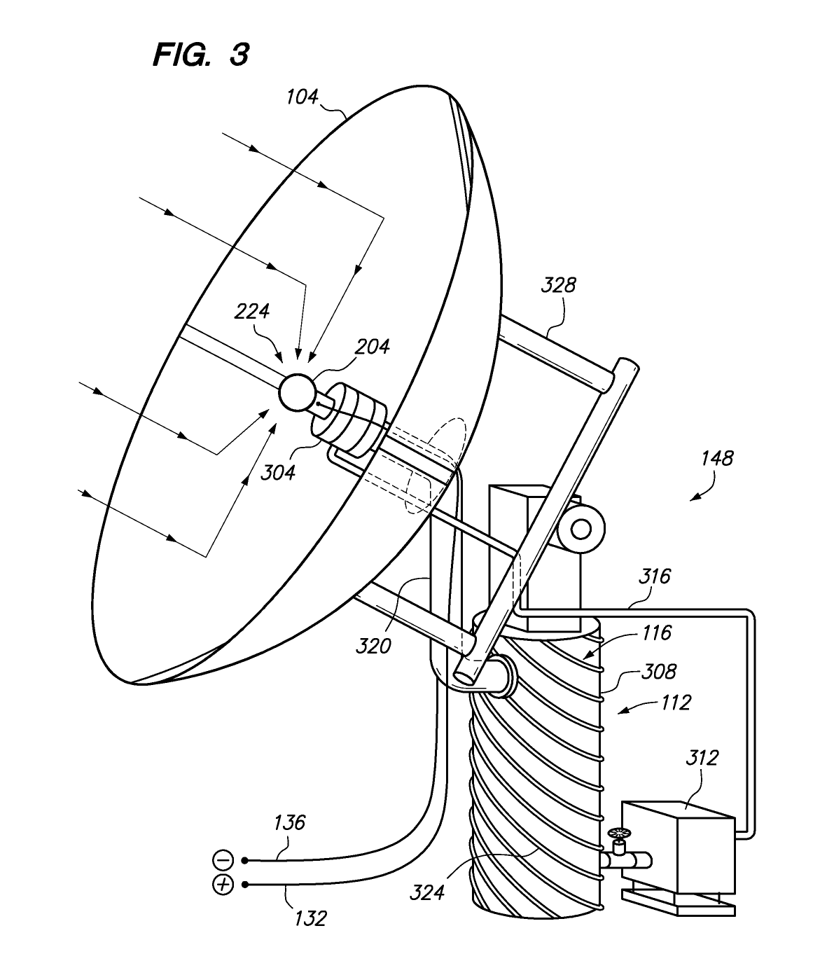

FIGS. 2A-2B illustrate an exemplary thermoelectric generator which may be used with the thermoelectric collector. As shown in the assembled view of FIG. 2A, the thermoelectric generator is a high density thermopile 204 having a heated end 224 and a cooled end 228. In general, the high density thermopile 204 will receive heat at its heated end 224 and dissipate heat at its cooled end 228 to create the temperature gradient used to generate electricity via the thermoelectric effect.

In contrast to traditional thermopiles, which are typically constructed of wire, the high density thermopile 204 has a generally solid mass which maximizes the thermoelectric effect in the volume occupied by the high density thermopile. The solid mass of the high density thermopile 204 also provides large surface area which makes the high density thermopile easier to heat and/or cool. For example, the large surface area allows heat from the sun to be more easily focused on the high density thermopile 204. In addition, the large surface area allows the high density thermopile 204 to dissipate heat as well as to be cooled by a cooling mechanism, as will be described further below.

The high density thermopile 204 may be configured in various ways. In one or more embodiments, the high density thermopile 204 may comprise dissimilar conductive materials and insulating materials. The insulating materials and dissimilar conductive materials may be arranged to form one or more thermocouples where the insulating materials prevent the dissimilar conductive materials from coming into contact along the length of the thermocouples but allow contact of the dissimilar conductive materials at the ends of the thermocouples to form the junctions of the thermocouples.

The dissimilar conductive materials may be various conductive materials. Typically, but not always, the conductive materials will be metals. For example, the conductive materials may be aluminum, copper, steel, iron, various alloys, or other metals. It is noted that various conductive materials, such as metals, may perform differently when used to generate electricity from the thermoelectric effect and that the dissimilar conductive materials may be selected based on their ability to generate electricity from the thermoelectric effect.

In addition, because the thermoelectric collector will typically be used outside, the dissimilar conductive materials, such as metals, may be selected based on their ability to withstand the elements or outdoor use. For example, in some embodiments, the materials may be exposed to allow maximum transfer of heat from the sun. In these embodiments, rust-proof or stainless metals may be used. In other embodiments, it is contemplated that the conductive materials may be covered for protection from the elements such as by one or more coatings or enclosures.

FIG. 2B illustrates an exploded view of an exemplary high density thermopile 204. As shown, the high density thermopile 204 comprises a first conductive material 208, a second conductive material 216, and insulating material 212. As stated, the conductive materials may be various metals. In one embodiment, the first conductive material 208 may be copper and the second conductive material 216 may be constantan. In another embodiment, the first conductive material 208 may be iron and the second conductive material 216 may be copper. In yet another embodiment, the first conductive material 208 may be copper and the second conductive material 216 may be constantan. Of course, various other combinations of metals and/or conductive materials may be used. Likewise, the insulating material 212 may be formed from a variety of one or more electrical insulators.

Thermocouple junctions 232 at the heated end 224 and the cooled end 228 of the high density thermopile 204 are formed by the arrangement of the first conductive material 208, second conductive material 216 and insulating material 212. The insulating material 212 separates the first conductive material 208 and the second conductive material 216 such that electricity is only conducted at the junctions of the first conductive material 208 and the second conductive material. In one or more embodiments, such as shown, these junctions will be located at the heated end 224 and the cooled end 228 of the high density thermopile 204.

As can be seen from the exploded view of FIG. 2B, the insulating materials 212 are shorter in length than the conductive materials 208,216. This allows an electrical connection between the conductive materials 208,216 to be made where the insulating materials 212 do not prevent such a connection. The insulating materials 212 may be staggered, such as shown, to allow electrical connections on alternating ends of the high density thermopile. These electrical connections form the thermocouple junctions 232 at the heated end 224 and cooled end 228 which allow electricity to be generated through the thermoelectric effect.

Though illustrated with a particular number of conductive materials 208,216 and insulating materials 212, it will be understood that a high density thermopile 204 may be constructed from more or fewer of such materials. This is another advantage of the high density thermopile 204. The capacity of the high density thermopile 204 to generate electricity from heat may be adjusted by removing or adding the conductive materials 208 and insulating materials 212.

It is contemplated that a conductive plate or compound may be placed at each thermocouple junction 232 to ensure conductivity between the conductive materials 208, 216 at the junction. For example, a conductive compound such as, but not limited to, graphite may be placed between conductive materials 208,216 at a thermocouple junction 232. The conductive plate or compound provides the benefit of ensuring conductivity at the junction. Also, the conductive plate or compound may have a thickness similar to or the same as the insulating materials 212. This prevents the conductive materials 208,216 from bending to form an electrical connection. Of course, a conductive plate or compound is not required in all embodiments.

The conductive materials 208,216 and insulating materials 212 may be shaped as planar sheets or plates of various thicknesses. In one embodiment for example, the conductive materials 208,216 may be between 0.01 in and 0.02 in thick. Typically, but not always, the conductive materials 208, 216 will have a similar shape and size. Though illustrated in a particular size, it will be understood that the conductive materials 208,216 and insulating materials 212 may be various sizes. For example, the conductive materials 208,216 and insulating materials 212 may have a longer length to increase the distance between the heated end 224 and the cooled end 228 of the high density thermopile 204. This is advantageous in that the longer length may allow various types of cooling mechanisms to be used. Of course, a shorter length may be used in one or more embodiments as well. It is contemplated that the insulating materials 212 may comprise a coating applied to one or more of the conductive materials 208,216 in some embodiments.

It is contemplated that the conductive materials 208,216 may be dimensioned according to the particular material or materials which make up the conductive materials. For example, the conductive materials 208,216 may be dimensioned to provide a particular voltage and/or current output. Conductive materials 208,216 may also or alternatively be dimensioned to provide a particular resistance. To illustrate, the resistance formula

$$R = \frac{ρ \cdot l}{A}$$

(where R is resistance, ρ is resistivity of the material, l is length of the material, and A is the cross-sectional area of the material), may be used to dimension a conductive material 208,216 to provide a desired resistance. It is noted that the configuration of the high density thermopile's conductive materials 208,216 may take into account their internal resistance. Thus, the designed output voltage/current may be higher than that required for electrolysis to occur to compensate for the internal resistance of the conductive materials 208,216. To illustrate, the designed output voltage may be approximately 3 v to produce approximately 1.5 v for electrolysis after internal resistance is taken into account.

In one or more embodiments, the materials making up the high density thermopile 204 may be arranged in a stack such as shown in FIGS. 2A-2B. The stack may be held together to form an assembled high density thermopile 204 in various ways. For example, one or more straps or the like may be wrapped around the high density thermopile 204. In one embodiment, the stack of materials may be placed in an enclosure to hold the materials together. It is contemplated that the materials may be pressed together as well. This ensures that electrical contact between conductive materials 208,216 of the stack may be made (where appropriate) to form the thermocouple junctions 232. It is contemplated also that the materials of the high density thermopile 204 may be adhered, welded, or otherwise secured together as well.

In some embodiments, the conductive materials 208,216 and insulating materials 212 may include one or more openings 220. The openings 220 may be positioned to align when the high density thermopile 204 is assembled. This allows one or more fasteners to be placed in and/or through the openings 220 to secure the conductive materials 208,216 and insulating materials 212 together. It is contemplated that the fasteners may be configured to apply pressure to clamp the conductive materials 208,216 and insulating materials together. In this manner, the fasters help to ensure that the conductive materials 208,216 remain in contact at the thermopile junctions. In one or more embodiments, the fasteners may be formed from non-conductive materials. This prevents unwanted electrical connections from being created by the fasteners.

The fasteners may be removable as well. For example, the fasteners may be threaded such as nuts, bolts, screws, and the like. This is advantageous in that additional conductive materials 208,216 and/or insulating materials 212 may be added to increase the electrical generating capacity of the high density thermopile 204. In addition, conductive materials 208,216 and or insulating materials 212 may be removed to reduce the size and capacity of the high density thermopile 204. Removable fasteners also allow one or more materials of the high density thermopile 204 to be removed and replaced if damaged or destroyed.

The openings 220 may be at the ends of the high density thermopile 204 in one or more embodiments. In these embodiments, one or more fasteners, when placed into the openings may help ensure electrical contact at the thermocouple junctions 232. To illustrate, one or more fasteners may secure portions of the conductive materials 208,216 together such that an electrical connection is made and a thermocouple junction 232 formed.

It is contemplated that the openings 220 may be at various other locations as well. For example, one or more openings 220 may be between the ends of the high density thermopile 204. This allows additional fasteners to be used to secure the conductive materials 208,216 and insulating materials 212 of the high density thermopile 204 together. This is advantageous in that it ensures the materials are held together even in high density thermopiles 204 having longer lengths.

As can be seen from FIGS. 2A and 2B, when assembled, the arrangement of the conductive materials 208,216 and insulating materials 212 form a high density thermopile 204 comprising a plurality of thermocouples. A series of thermocouple junctions 232 are also formed at the heated end 224 and the cooled end 228 of the high density thermopile 204. This allows electricity to be generated via the thermoelectric effect through a temperature gradient between the heated end 224 and the cooled end 228.

In addition, when assembled, the high density thermopile 204 has a generally solid structure which lends itself to heat transfer. As discussed above, this is advantageous in both heating and cooling the high density thermopile. Consequently, the high density thermopile 204 is ideally suited to take advantage of the thermoelectric effect.

An exemplary high density thermopile 204 will now be described to illustrate the output capabilities of the high density thermopile. The exemplary high density thermopile 204 comprises a first conductive material 208 of copper, and a second conductive material 216 of constantan. In addition, the exemplary high density thermopile 204 has a particular number of junctions and a particular size. It will be understood however that the following disclosure/calculations may be applied to a variety of high density thermopiles 204.

A section or layer of the copper conductive material 208 may be 2 in×0.01 in×10 in, while a section or layer of the constantan conductive material 216 may be 2 in×0.02 in×10 in. In the exemplary high density thermopile 204, 160 thermopile junctions 232 may be formed giving the copper conductive material 208 a total length of 1600 in and the constantan conductive material 216 a total length of 1600 in. With the above values and a resistivity ρ for copper and constantan the resistance of the conductive materials 208,216 may be determined.

For example, assuming a resistivity p for copper of 1.68·10⁻⁸ and a ρ for constantan of 49·10⁻⁸ the resistance formula,

$$R = \frac{ρ \cdot l}{A} ,$$

yields a resistance R=0.0529Ω for copper and R=0.7717Ω for constantan. To illustrate, (first converting from inches to meters), the resistance formula yields

$$\frac{1.68 \cdot {10}^{- 8} Ω m \cdot 40.64 m}{2.54 \cdot {10}^{- 4} m \cdot 0.508 m} = 0.0529 Ω$$

for copper, while the resistance formula yields

$$\frac{49 \cdot {10}^{- 8} Ωm \cdot 40.64 m}{5.08 \cdot {10}^{- 4} m \cdot 0.508 m} = 0.7717 Ω$$

for constantan. Accordingly, total resistance of the high density thermopile 204 is 0.7717 Ω+0.0529 Ω=0.8246Ω. It is noted that the resistance at the thermopile junctions 232 may, if desired, be taken into account in determining high density thermopile 204 output.

As stated, a high density thermopile 204 may be used to power electrolysis, such as to generate hydrogen. Assuming electrolysis occurs at approximately 1.5 v, the current available from the high density thermopile 204 to produce electrolysis is approximately 1.82 A. To illustrate, using Ohm's Law,

$$I = \frac{V}{R} ( where I is current , V is voltage and R is resistance ) , \\ \frac{{1.5}_{v}}{0.8246 Ω} = 1.82 A .$$

Assuming an available gas volume of 0.627 LPH/A, the exemplary high density thermopile 204 at 1.82 A would produce 1.14 L of gas per hour.

FIG. 3 illustrates an exemplary apparatus which may be used with a high density thermopile 204 to generate electricity via the thermoelectric effect. In general, the apparatus heats one end of the high density thermopile 204 while cooling another end of the thermopile to create a temperature gradient along the thermopile. As shown in FIG. 3, the apparatus includes a solar concentrator 104 in the form of a parabolic dish, a high density thermopile 204, and a cooling mechanism 148.

The solar concentrator 104 is configured to focus the sun's energy on the high density thermopile 204. The solar concentrator 104 may be mounted to a support 328 which secures the concentrator at a position suited to receive energy from the sun. It is contemplated that the support 328 may be rotatable to track the sun ensuring that substantial amounts of the sun's energy are collected by the solar concentrator 104. The support 328 may be motorized and/or automated to automatically track the sun in one or more embodiments.

As can be seen, the high density thermopile 204 may be positioned at a central location relative to the parabolic dish of the solar concentrator 104. In this manner, the sun's energy may be focused on the heated end of the high density thermopile 204. Of course, the high density thermopile 204 may be positioned at other locations. For example, the high density thermopile 204 may be positioned such that its heated end is wherever the solar concentrator 104 focuses the sun's energy.

The high density thermopile 204 may also be shaped to better absorb heat energy provided by the solar concentrator 104. For example, as shown, the heated end of the high density thermopile 204 is bulb shaped. This provides additional surface area to absorb heat provided by the solar concentrator 104. This is advantageous such as where the solar concentrator 104 cannot tightly focus heat energy on a high density thermopile 204 with a smaller surface area.

In one embodiment, the bulb shape may be formed by shaping the conductive and insulating materials of the high density thermopile 204 with the desired shape. It will be understood that various other shapes may be used as well. Alternatively, or in addition, the high density thermopile 204 may be fitted with a bulb or other shaped cover which provides the larger surface area for collecting heat energy. This cover may be formed from material that efficiently transfers heat, such as one or more metals.

One or more electrical leads may be connected to the high density thermopile 204 to allow electricity generated by the thermopile to be transferred to generate hydrogen or for other uses. As shown, a positive lead 136 and a negative lead 132 are connected to the high density thermopile 204. As stated above, electricity form the high density thermopile 204 may be used to power electrolysis to generate hydrogen. In addition, the electricity may be used to power portions of the thermoelectric collector, such as a motor or other device for moving the support 328, or a pump 312 of the thermoelectric collector. Of course, the generated electricity may be used for other purposes as well.

While the heated end of the high density thermopile 204 is heated by the solar concentrator 104, the cooled end of the high density thermopile is preferably cooled by a cooling mechanism 148. In the apparatus of FIG. 3, the cooling mechanism 148 utilizes water to cool the high density thermopile 204. More specifically, water flows over the cooled end of the high density thermopile 204 absorbing heat from the thermopile and thus cooling the cooled end of the thermopile. The water itself is then cooled and then recirculated back to the high density thermopile 204 to absorb heat from the thermopile once again. This water flow may be accomplished in various ways.

As shown, the cooling mechanism 148 utilizes a quench ring 304 into which at least the cooled end of the high density thermopile 204 is inserted. Water from a supply line 316 may be emitted or dispensed from the quench ring 304 such that the water comes into contact with the high density thermopile 204, cooling the thermopile. The water then flows through a return line 320 to a heat exchanger 112 which cools the water by absorbing heat from the water. The heat exchanger 112 may be a water reservoir 308 which absorbs heat from the water.

One or more heat dissipaters 116 may then be used to remove or dissipate heat from the heat exchanger 112 to allow the heat exchanger 112 to continue to absorb heat from the water. Typically, but not always, the heat dissipaters 116 will dissipate heat to the environment. In the embodiment of FIG. 3, the heat dissipaters 116 comprise one or more cooling fins 324 which provide increased surface area allowing heat to be dissipated into the surrounding air.

The cooling mechanism 148 may also comprise a pump 312 and supply line 316 for the quench ring 304. In one or more embodiments, the pump 312 may be attached to the heat exchanger 112 and the supply line 316. Water cooled by the heat exchanger 112 water may be pumped by the pump 312 back to the quench ring 304 through the supply line 316. In this manner, the water used for cooling the high density thermopile 204 is recirculated and not wasted. It is contemplated that water may not be recirculated in some embodiments as city, well, lake, ocean, or other water may be pumped to the quench ring 304. In these embodiments, a heat exchanger 112 and heat dissipater 116 may not be required, though they may be used to cool the water before it is returned to its source to reduce heat pollution. It is noted that the supply of cooling water may be replenished if low from various water supplies. It is also noted that other fluids or coolants besides water may be used with the cooling system 148 to cool the high density thermopile 204.

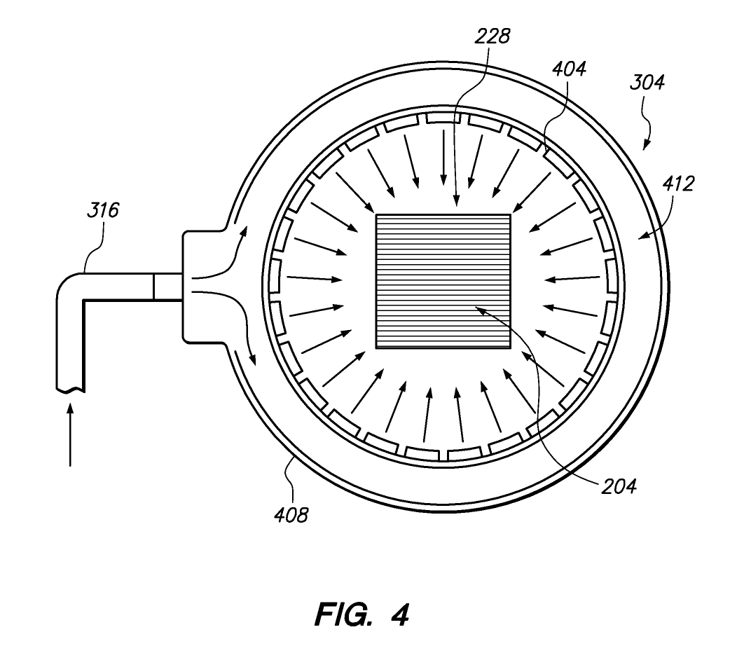

FIG. 4 is a top view illustrating an exemplary quench ring 304. The heated end of a high density thermopile 204 is inserted or located in the quench ring 304. As shown, the quench ring 304 comprises a channel 412 in fluid communication with one or more nozzles 404 on the interior surface of the quench ring. As can be seen, water from the supply line 316 may enter the channel 412 and be distributed onto a high density thermopile 204 by the one or more nozzles 404. Water from the supply line 316 may be under pressure to give the water sufficient velocity out of the nozzles 404 to reach the high density thermopile 204 in one or more embodiments. Referring back to FIG. 3, after cooling the high density thermopile 204, the water may then flow from the quench ring 304 to the return line 320 to be cooled and/or recirculated by the remainder of the cooling mechanism 148 such as described above.

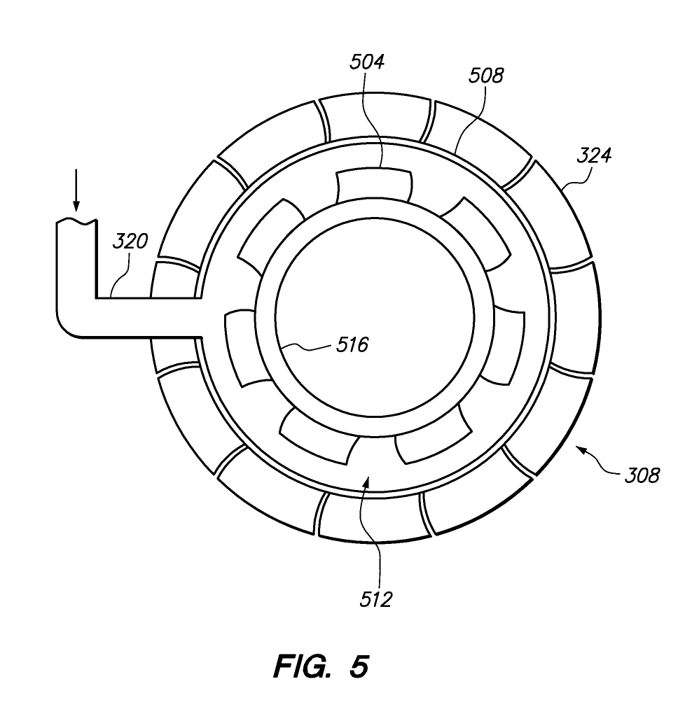

FIG. 5 is a top view of a water reservoir 308. The water reservoir 308 has an outer wall 508 defining an interior space. One or more cooling fins 324 are located at an exterior of the outer wall 508. As shown, the water reservoir 308 also includes an inner core 516 comprising one or more deflectors 504. The inner core 516 is located within the interior space and forms a space or void 512 for water flow between the inner core 516 and outer wall 508 of the water reservoir. The water reservoir 308 may accept water from the return line 320 through its outer wall 508. This water may be deflected by the one or more deflectors 504 toward the outer wall 508. Heat from the water is then transferred to the outer wall 508 and ultimately dissipated by the cooling fins 342 to the environment.

The deflectors 504 may be shaped and/or positioned to deflect water onto the outer wall 508. For example, the deflectors 504 may be curved and/or angled to deflect water flows in this manner. The deflectors 504 may be arranged in a spiral pattern moving up (or down) the length of the inner core 516 in some embodiments. In one embodiment, the inner core 512 may rotate or spin to move the deflectors 504. Water flows may then be deflected onto the outer wall 508 by the centrifugal motion of the deflectors 504.

Though shown with a particular configuration, it is noted that the inner core 516 and deflectors 504 may be configured in various ways. For example, the inner core 516 may be sized to reduce the area of the void 512 between the inner core and outer wall 508. This is advantageous in that it helps ensure that water from the return line 520 comes into contact with the outer wall 508. In addition, or alternatively, the deflectors 508 may extend closer to the outer wall 508 or even contact the outer wall 508 to ensure water contact with the outer wall. In one embodiment, the deflectors 508 may form a spiral (like the threads of a screw) to allow constant or near constant water contact with the outer wall 508 as water flows along the spiral through the water reservoir 308. This allows the water to be effectively cooled by the water reservoir 308 and cooling fins 324.

In some embodiments, the high density thermopile 204 may be allowed to cool itself. For example, the heated end may be heated by a device or apparatus while the cooled end is allowed to dissipate heat without the assistance of any device or apparatus.

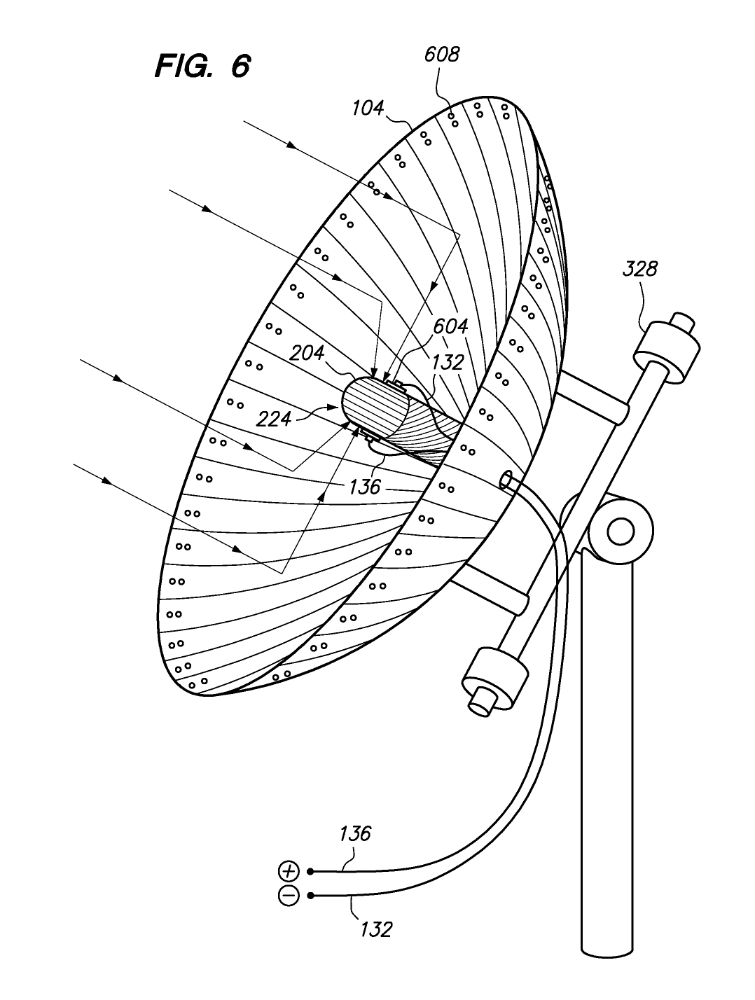

FIG. 6 illustrates an embodiment where the high density thermopile 204 is configured to cool itself. This is advantageous in that the number of components of a thermoelectric collector may be reduced thus reducing expense and potentially increasing reliability. In addition, self cooling generally does not utilize a power source and thus has a higher energy efficiency.

As can be seen, the apparatus of FIG. 6 utilizes a parabolic dish as a solar concentrator 104. In this embodiment, the parabolic dish focuses heat energy from the sun onto the heated end of a high density thermopile 204. Similar to the above apparatus, the solar concentrator 104 may be mounted to a support 328. The support 328 allows the solar concentrator 104 to be oriented to receive heat energy from the sun. In addition, as described above, the support 328 may rotate or move to track the sun.

In one or more embodiments, the high density thermopile 204 may be configured to form the solar collector 104. As can be seen from FIG. 6, the materials forming the high density thermopile 204 may twist and fan outward while curving to form the parabolic shape of the solar collector 104. In this manner, the heated end 224 of the high density thermopile 204 is positioned at a central location of the solar collector 104 to absorb the heat energy focused by the solar collector. The cooled end 228 of the high density thermopile 204 is remote from the heated end 224 to allow a temperature gradient between the heated end and the cooled end. In one or more embodiments, the cooled end 228 of the high density thermopile 204 may be the outer rim or edge of the solar collector 104, such as shown.

The cooled end 228 of the high density thermopile 204 may function as its own cooling mechanism by allowing heat absorbed by the heated end 224 to dissipate into the surrounding environment. In one or more embodiments, one or more holes 608 may be formed at the cooled end 228 of the high density thermopile 204 to aid in dissipating heat by allowing air flow to carry away heat. In this way, the one or more holes 608 may function as heat dissipaters.

It is noted that the cooled end 228 may also be cooled in other ways. For example, a flow of water or other coolant may be provided by one or more conduits running along the cooled end 228. The coolant may absorb heat from the cooled end to cool the cooled end 228. The cooling mechanism described above as well as other cooling mechanisms may be used as well.

As stated above, materials of the high density thermopile 204 may be secured together by one or more fasteners. In the embodiment of FIG. 6 one or more fasteners 604 may be used to secure the heated end, cooled end, or both ends of the high density thermopile 204. In addition, one or more electrical leads may be attached to the high density thermopile 204 to allow the electricity generated by the thermopile to be transferred from the thermopile for generation of hydrogen or other uses. For instance, in the embodiment shown, a positive lead 136 and a negative lead 132 are connected to the high density thermopile 204.

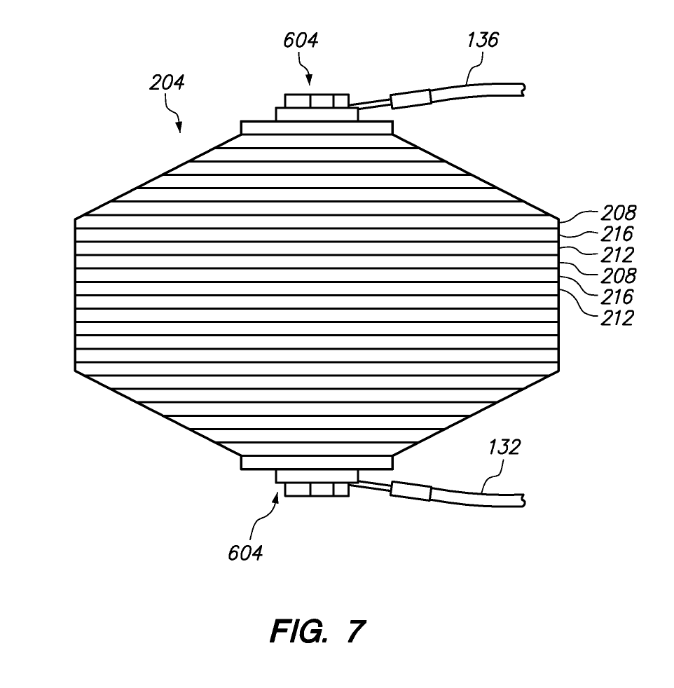

FIG. 7 is a top view of the high density thermopile 204 having a positive lead 136 and a negative lead 132 connected thereto. The high density thermopile 204 may be held or secured together by one or more fasteners 604, such as shown. As can be seen, the heated end of the high density thermopile 204 may be shaped in various ways. In this manner, a bulb-like shape for the heated end (such as shown in FIGS. 3 and 6) of the high density thermopile 204 may be formed. It is noted that the cooled end may be shaped as well in one or more embodiments.

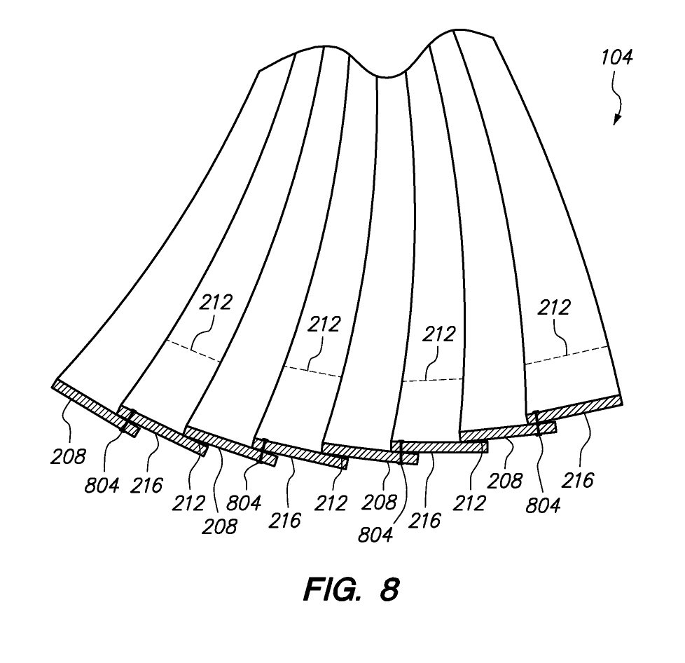

As can be seen, the high density thermopile 204 comprises dissimilar conductive materials 208,216 and insulating materials 212 arranged to form the high density thermopile. FIG. 8 is a perspective view of a portion of the parabolic dish formed by the high density thermopile 204. As can be seen, the conductive materials 208,216 may fan apart and curve to form the parabolic surface of the solar collector 104. One or more additional fasteners 604 may be used to secure the materials of the high density thermopile 204 together. As shown in FIG. 7, the fasteners 604 have been installed at the thermopile junctions 232 to ensure electrical contact between the conductive materials 208,216. Of course fasteners 604 may be installed at other locations as well. As stated above, the fasteners 604 may be nonconductive in one or more embodiments and may be removable as well. In one embodiment the fasteners 604 may be screws, nuts, bolts, pins, clamps, clips, or the like. The fasteners 604 may also be welds or crimps as well.

Similar to the high density thermopile 204 of FIGS. 2A-2B, insulating material 212 may be arranged within the high density thermopile to allow electrical contact between the conductive materials 208,216 at the thermocouple junctions 232 but not along the length of the conductive materials. Referring back to FIG. 8, it can be seen that the insulating materials 212 may be staggered to form thermocouple junctions 232 on alternating ends of the high density thermopile 204. To illustrate, the insulating material 212 between the first pair of conductive materials 208,216 may be configured to not extend to the end of the conductive materials to form a thermocouple junction 232 between the conductive materials 208,216. The next insulating material 212 (shown to the right of the leftmost insulating material in FIG. 8), may extend to the ends of the conductive materials 208,216. In this manner, thermocouple junctions 232 on alternating ends of the high density thermopile 204 may be formed.

The fanning out of the high density thermopile 204 as it reaches the cooled end 228 not only forms the parabolic dish of the solar concentrator 104, but also provides increased surface area which aides in heat dissipation and improves cooling. The portions of the conductive materials 208,216 which form the surface of the parabolic dish may be treated so as to better reflect heat energy towards the heated end of the high density thermopile 204.

For example, the conductive materials 208,216 may be polished to have a reflective or shiny surface. Alternatively or in addition, the conductive materials 208, 216 may be coated or covered with heat reflective materials or coverings. For example, a parabolic reflective covering may be used. Though the sun's heat may heat the cooled end 228 to a certain extent, it is noted that the cooled end will be cool relative to the heated end 224 thus generating the temperature gradient required to generate electricity through the thermoelectric effect.

It is noted that though shown with particular apparatus, the high density thermopile may be used with other devices or apparatus as well. In general, the high density thermopile may be used with any heat generating and/or heat concentrating device or apparatus as long as sufficient heat is provided to the heated end of the thermopile to generate electricity via the thermoelectric effect. Likewise the high density thermopile may be cooled by dissipating heat itself or by various cooling mechanisms.

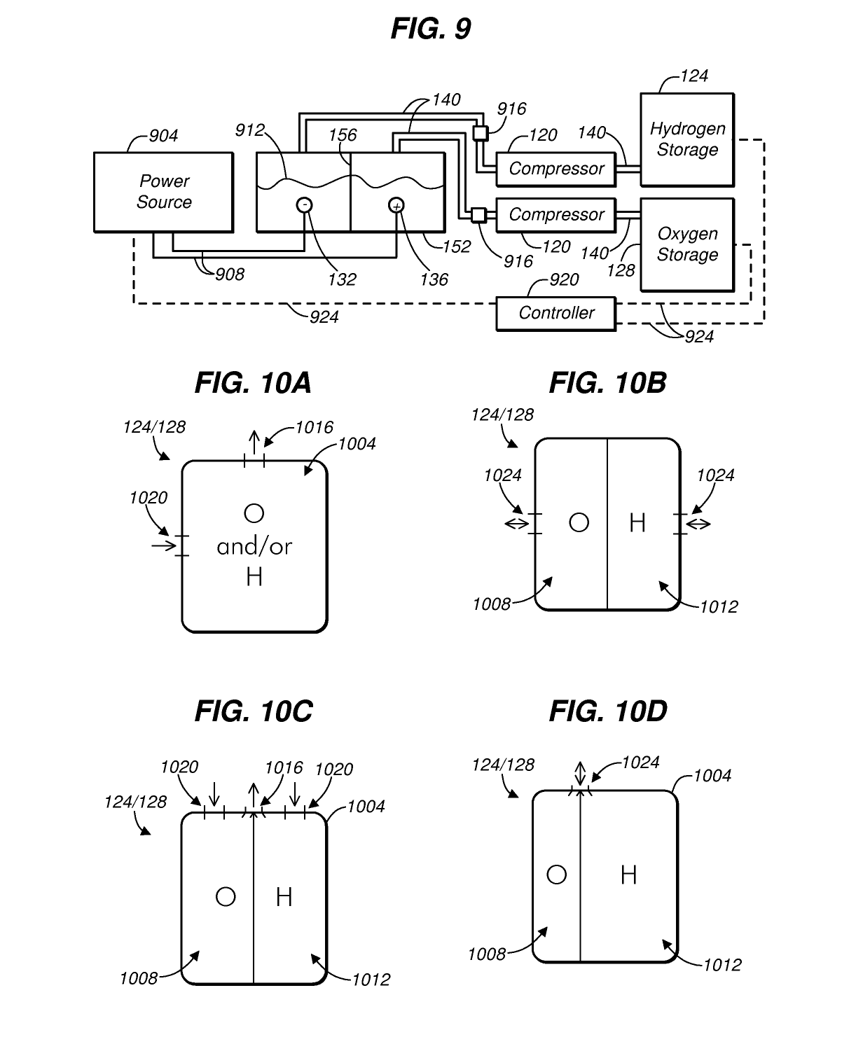

The hydrogen generation and storage concepts herein may be used with a variety of energy sources. FIG. 9 illustrates an exemplary hydrogen generation and storage system for collection and storage of energy. The hydrogen generation and storage system generates a clean environmentally friendly fuel in a clean and environmentally friendly way. Namely, the hydrogen generation and storage system produces hydrogen gas that, when burned, releases water. This is unlike fossil fuels, such as propane, natural gas, gasoline, and diesel which all produce polluting and sometimes toxic byproducts when burned.

As can be seen in FIG. 9, the hydrogen generation and storage system may comprise a hydrogen generation subsystem. The hydrogen generation subsystem may comprise a power source 904 and a electrolysis chamber, such as the water tank 152 shown. The power source 904 may be connected to one or more positive electrodes 136 and one or more negative electrodes 132 positioned within the water tank 152. One or more electrical conduits 908 may be used to make this connection.

In general, the power source 904 is configured to provide an electrical current to the negative and positive electrodes 132,136. A connection between the power source 904 and electrodes 132,168 may be made with one or more electrical conduits 908. As the current passes through an electrolyte, such as water 912, electrolysis occurs. In the case of water, the electrolysis generates hydrogen and oxygen gas. At the side of the water tank 152 having the negative electrode 132 hydrogen gas is generated, while oxygen gas is generated at the side of the water tank 152 having the positive electrode 136. The hydrogen and oxygen generated by this process is pure or substantially pure. This is highly beneficial in that it does not contaminate fuel cells or other fuel utilizing devices. This is in contrast to hydrogen generated from hydrocarbons, which contain contaminants that negatively affect the operation of fuel cells.

As can be seen, the water tank 152 may be divided by a diaphragm 156 which keeps the generated hydrogen and oxygen separated. It is contemplated that the diaphragm 156 may be permeable and/or conductive at least beneath the water surface so as to allow water and/or electrical current to pass through the diaphragm. Alternatively, the diaphragm 156 may only extend from the top of the water tank 152 to a location at or slightly below the water surface. This seals the top portion of the water tank to separate the hydrogen and oxygen gas.

It is noted that in some embodiments, a diaphragm 156 may not be provided. In this manner, oxygen and hydrogen may be collected together. Such a mixture of gases may be beneficial in that the addition of oxygen may produce a more potent fuel as will be discussed further below.

The power source 904 may have a variety of configurations. Typically, a renewable or other “green” energy source will be used as a power source 904. For example, the power source 904 may be a solar, wind, geothermal, or wave powered power source. In a solar embodiment, the power source may comprise solar panels, solar collectors combined with steam or other turbines, thermopiles, or other devices which can convert the sun's heat or light into electricity.

It is contemplated that a power source 904 may generate electric current in a combination of ways. For example, the power source 904 may utilize various combinations of solar, wind, geothermal, and/or wave power. The power source 904 may also store heat in some situations, such as to allow the power source to generate electricity even in undesirable conditions. For example, a solar power source 904 may store heat from the sun as molten salt, or the like, and utilize this stored heat to generate electricity even when the sun is down or blocked by clouds or weather.

The power source 904 may be independent of the power grid in one or more embodiments. In this manner, the power source 904 is capable of operating without any connection to or from the power grid. This is advantageous in that it allows the hydrogen generation and storage system to be used virtually anywhere to produce and store hydrogen and oxygen. For example, in a remote area, hydrogen could be generated during the day by a solar power source, or by a wind turbine when there is sufficient air movement. When there is no longer sunlight or sufficient air movement, the stored hydrogen may be used as fuel even in remote areas that are not connected to the grid. When burned, the hydrogen is converted to water which may then be consumed by people or used again in electrolysis to produce hydrogen.

As electrolysis occurs, the hydrogen and oxygen being generated may be captured by a hydrogen storage subsystem. The hydrogen storage subsystem may comprise one or more conduits or pipes 140, storage tanks 124,128, or both. For example, one or more conduits or pipes 140 may be connected to the water tank 152. In general, at least one pipe 140 would be at the side or section of the water tank 152 having the positive electrode 136. At least one other pipe 140 would be at the side or section of the water tank 152 having the negative electrode 132. Such a configuration is shown in FIG. 9. In this manner, the generated hydrogen at the negative electrode 132 and generated oxygen at the positive electrode 136 may respectively flow into the appropriate pipe(s) 140.

It is noted that the water tank 152 may be pressurized in one or more embodiments, such as to force the generated hydrogen and oxygen into the pipes 140. This is beneficial because the hydrogen/oxygen may then be already compressed or at a high pressure when it reaches the storage tanks. This increases the system's efficiency in that it reduces or eliminates the need to compress the hydrogen/oxygen at the storage tanks. Pressurizing the water tank 152 allows increased pressure, such as a 2700 psi in the storage tanks, while using substantially less energy. For example, the 2700 psi in the storage tanks may be generated with as low as 3% of the energy required to pressurize the tanks directly in some embodiments. It is contemplated that the water tank 152 may be pressurized by one or more compressors. Other devices may be used pressurize the water tank 152 as well. For example, a spring power or motorized plate, wall, or other portion of the water tank 152 may be moved inward to pressurize the water tank.

A valve may be used, such as at the location where one or more pipes 140 connect to the water tank 152, to allow the hydrogen, oxygen, or both to be compressed while within the water tank. Once the hydrogen, oxygen, or both are above a particular pressure, the valve may allow the hydrogen/oxygen to be released into the one or more pipes 140. It is contemplated that various gases may be used to pressurize the water tank 152. For example, oxygen may be forced (such as by a compressor) into the side or section of the water tank 152 that is generating oxygen, while hydrogen may be forced into the side or section of the water tank that generates hydrogen. Alternatively, the use of the valve described above may allow the water tank 152 to pressurize itself by not releasing generated hydrogen/oxygen until a preset pressure is reached within the water tank.

Alternatively the hydrogen storage subsystem's pipes 140 may have a fan, compressor, vacuum or the like may be used to push or pull the hydrogen and oxygen into the pipes. It is contemplated that the pipes 140 may have one or more valves 916 to control the flow of gas therein. For example, a one-way valve may be provided in-line with the one or more pipes 140 to prevent gas from flowing back into the water tank 152. It is noted that the compressors or storage tanks may also or alternatively have valves.

The pipes 140 may extend to one or more storage devices, such as the hydrogen and oxygen storage tanks 124,128 illustrated in FIG. 9. It is contemplated that the fan, compressor, vacuum, or the like may be connected to the pipes 140 between the storage tanks 124,128 and the water tank 152. In this manner, the fan, compressor, vacuum, or like device may force the hydrogen and oxygen into their respective storage tanks 124,128 or devices. For instance, FIG. 9 illustrates individual compressors 120 configured to compress the generated hydrogen and oxygen for storage in the hydrogen storage tank 124 and oxygen storage tank 128, respectively.

Some exemplary storage tanks 124,128 will now be described with regard to FIGS. 10A-10D, which show individual storage tanks. In general, the storage tanks 124,128 provide a container or compartment 1004 configured to safely store and contain one or more gases without leakage. The storage tanks 124,128 may comprise one or more inlets 1020, one or more outlets 1016, or both to allow gas to be stored in and removed from the storage tanks. For example, the inlets 1020 and/or outlets 1016 may be connected to a pipe 140 to respectively receive or release gas into or out of the storage tanks 124,128.

The storage tanks 124,128 may have a variety of configurations. For instance, the storage tanks 124,128 may have various shapes. To illustrate, the storage tanks 124,128 may be square or rectangular such as to allow them to be conveniently stacked and stored. The storage tanks 124,128 may have shapes matching that of existing fuel tanks, such as existing fossil fuel tanks. In this manner, the storage tanks 124,128 may be easily swapped with existing tanks, such as to retrofit a fuel burning device.

The storage tanks 124,128 may range in size from small to very large. For example, the storage tanks 124,128 may be a personal storage tank having a conveniently small size like that of commercially available propane tanks for consumer use. Alternatively, the storage tanks 124,128 may be larger, such as to store enough hydrogen to power a residence, building, or even several buildings. It is noted that the hydrogen could also be used to power individual devices such as vehicles, cooktops, heaters, and other fuel burning devices. It is contemplated that the storage tanks 124,128 may be configured to store anywhere between one gallon to several thousand or million gallons of hydrogen in compressed or uncompressed form.

Since the power source 904 is typically powered by a non-polluting source provided by nature, storage tanks 124,128, even ones that are very large, may be continuously filled with generated gas as long as the environment provides sufficient power whether that be by solar, wind, wave, or geothermal, or other means. The hydrogen and oxygen generated is very low cost, if not free, since the power source 904 may be powered by naturally occurring forces.

It is contemplated that the pipes 140 may have one or more fittings or nozzles at their ends. In this manner, the storage tanks 124,128 may be swapped for new storage tanks as desired or required. For instance, a storage tank 124,128 that is full may be replaced for another on. Alternatively, a larger or smaller storage tank 124,128 may be used by connecting such tank to a pipe 140.

In some embodiments, a single storage tank 124,128 may be used for each individual gas. Such a storage tank 124,128 is shown in FIG. 10A. In other embodiments, a single storage tank 124,128 may store multiple distinct gases. For example, a storage tank 124,128 may have separate compartments 1008,1012 for oxygen and hydrogen, such as shown in FIGS. 10B-10D. The storage tank 124,128 may have at least one access point or inlet 1020 or a two-way port 1024 for each compartment 1008,1012 to be filled with the appropriate gas, such as shown in FIG. 10B.

Storing both hydrogen and oxygen in one storage tank 124,128 allows both the hydrogen and oxygen to be transported and/or used together. For example, during use, at least some oxygen from the storage tank may be mixed with the hydrogen (also form the storage tank) to increase the combustibility/potency of the hydrogen gas. It is contemplated that the storage tank 124,128 may have a single combined outlet 1016 which provides both hydrogen and oxygen, such as shown in FIG. 10C. The combined outlet 1016 may comprise one or more valves which control the amount of oxygen released relative to the amount of hydrogen being released. This is advantageous in controlling the combustion of the hydrogen when used. It is noted that a combined two-way port 1024, such as shown in FIG. 10D may also be provided. Such a two-way port 1024 allows input and output of more than one type of gas to and from the appropriate compartment 1008,1012 of a storage tank 124,128.

In embodiments where hydrogen and oxygen are used together, it is noted that a desired mix of hydrogen and oxygen may be produced before the gases are stored in a storage tank 124,128. For example, a measured quantity of oxygen and hydrogen may be mixed, such as by controlling the flow rate of either of both gases into a storage tank 124,128 or mixing chamber. If a separate mixing chamber is used, the mixed gas may then be transferred from the mixing chamber to a storage tank. In such embodiments, the storage tank 124,128 need only have a single gas storage compartment 1004 since the gases are pre-mixed, such as shown in FIG. 10A.

In one embodiment, the flow rate of oxygen may be less than that of hydrogen. This may be accomplished by opening or closing one or more valves (such as a valve of the storage tank's inlets, outlets, or two-way ports) until the flow rate of each gas is as desired. The resulting gas, which is made up mostly of hydrogen and some oxygen or vice versa, may then be stored in a storage tank 124,128. As can be seen, it is beneficial to have separate pipes 140 from the water tank 512 for oxygen and hydrogen in such embodiments to allow the flow rates of the individual gases to be more easily controlled.

It is contemplated that multiple combination hydrogen and oxygen storage tanks may be connected to the water tank 152 in some embodiments. Each or some of the storage tanks may be used to store gas having a different ratio of hydrogen to oxygen. In this manner, different mixtures of the gases may be produced and provided for various uses. For example, higher oxygen content may be desirable for powering vehicle engines while lower oxygen content may be desirable for cooking, furnaces, or fireplaces.

Oxygen is typically useful in reactions where the hydrogen gas is combusted or burned. For example, hydrogen gas may be burned to heat water creating steam to generate electricity or motion, to power vehicles (on Earth and in space), to provide heat in furnaces and fireplaces, to cook food or as a replacement for natural gas, etc. . . . . Oxygen and hydrogen may also be combined in a hydrogen fuel cell to generate electricity. Thus, it can be seen, that the mutual storage of oxygen and hydrogen may be highly advantageous in some circumstances. This is especially so, where as here, the hydrogen and oxygen generated by the generation subsystem is pure or substantially pure.

It is noted that storage tanks 124,128 are not necessary in all embodiments since the hydrogen and/or oxygen may be piped or pumped directly to consumers or fuel consuming devices for use. For example, it is contemplated that the hydrogen may be provided directly to residences and buildings via a network of pipes. Alternatively, the hydrogen may be provided directly to an electrical generator which is powered by hydrogen, such as a fuel cell or hydrogen burning engine.

Referring back to FIG. 9, it can be seen that the hydrogen generation and storage system may optionally include at least one controller 920. In general, the controller 920 is configured to control the operation of various components of the hydrogen generation and storage system. For example, as shown, the controller 920 is in communication with the power source 904 and the storage tanks 124,128. Such communication may be accomplished through one or more communication links 924. It is noted that other components of the hydrogen generation and storage system, such as water tanks 152, compressors 120, or valves 916 may be in communication with and controlled by a controller 920.

In one or more embodiments, a controller 920 may be configured to control the flow of electricity, the flow of hydrogen and/or oxygen, or both. For example, the controller may route electrical output from a power source 904 to various consumers or destinations. In one embodiment, the controller 920 may select between routing electricity to the water tank 152 for electrolysis, or routing electricity to serve other demand for electricity (e.g., one or more electricity consuming devices).

For example, in one embodiment, only excess power from the power source may be routed or transmitted to the water tank 152 to power electrolysis by the controller 920. This allows the power source to meet demand for electricity from other uses or devices. Any excess electricity is diverted to generate hydrogen at the water tank 152. In this manner, the excess capacity of the power source 904 is not wasted. This is highly beneficial especially where the power source 904 is powered by natural forces (e.g., wind, sun, water, geothermal) which may not always be present when desired. This is because the power source 904 may generate its maximum or peak output without waste and take advantage of natural energy sources whenever they are available. The excess electrical output is then stored in the form of hydrogen for later use.

Alternatively, it is noted that the controller 920 may be configured to always provide power to the water tank 152 regardless of other demands for electricity. It is contemplated that the amount of power provided to the water tank 152 may be increased when other demands are low and decreased when other demands are high.

In addition or alternatively, a controller 920 may select between storing or releasing hydrogen and/or oxygen from the hydrogen storage subsystem. For example, where other demands for electricity exceed the current electrical output of the power source 904, the controller 920 may release hydrogen and/or oxygen from the hydrogen storage subsystem (e.g., the storage tanks 124,128). Once released, at least the hydrogen may be used as fuel to power additional generators or the power source 904 itself (depending on the configuration of the power source). The oxygen may also be released and used with the hydrogen, such as to enhance the power output of hydrogen. Some exemplary generators that may use the hydrogen and/or oxygen include fuel cells and hydrogen powered steam turbines. Other hydrogen powered generators of electricity may also be used.

It is contemplated that the controller 920 may also control these hydrogen powered generators. For example, when or after hydrogen is released, the controller 920 may also command one or more hydrogen powered generators to begin operation to generate and supplement the electrical output of the power source 904. The controller 920 may also control the amount of power generated by the hydrogen powered generators, so as to not waste the hydrogen fuel. Typically, the controller 920 will instruct the hydrogen powered generator(s) to output enough electricity to meet the amount of electricity being demanded.

Multiple controllers 920 may be provided in some embodiments. For example, individual controllers 920 may control an aspect of the operation of the hydrogen generation and storage system or a component thereof. The controllers 920 may be in communication to coordinate their operation.

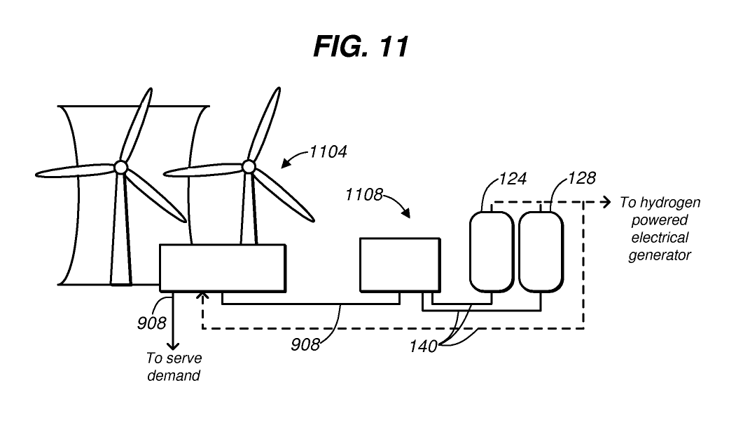

The hydrogen generation and storage system may be used with various forms of electrical power sources ranging from small to large. For example, as illustrated in FIG. 11, hybrid power plant could be built by combining a traditional power plant 1104 with the hydrogen generation and storage system 1108. Such a plant would be highly efficient and could be operated at or near its rated capacity (which is most likely its most efficient operating range). Any power generation capacity beyond current demands on the plant may be used to power the hydrogen generation and storage system 1008, such as disclosed above. Thus, rather than going to waste, the excess capacity generates hydrogen which may then be used to provide additional power when needed. Alternatively, the hydrogen could be used for a variety of other useful purposes, such as those described above.

To illustrate with an example, consider a 100 megawatt power plant 1104 that produces power through wind or solar energy. The demand on the plant 1104 would fluctuate with the demands of its consumers. For example, demand may be low during evenings and high during hot weather or as consumers return home from work. With the hydrogen generation and storage system 1108, the plant 1104 may be configured to always produce its maximum possible power output. Any excess capacity (i.e., capacity in excess of current electrical demand) would be diverted to the hydrogen generation and storage system 1108 to generate and store hydrogen and oxygen, such as in one or more storage tanks 124,128. As can be seen from FIG. 11, one or more electrical conduits 908 may transfer electricity from the plant 1104 to the hydrogen generation and storage system 1108. It is noted that, as described above, one or more controllers may govern the distribution/routing of electricity between the hydrogen generation and storage system and other uses or demands.

If the wind or sun is insufficient to meet consumer demands for a particular time period, the stored hydrogen, oxygen, or both may be burned or consumed to produce electricity to increase electrical output by the plant 1104 in a clean environmentally friendly manner. To illustrate, in FIG. 11, one or more pipes 140 may be used to feed stored hydrogen and/or oxygen from the storage tanks 124,128 back to the plant 1104 or to another hydrogen powered electrical generator (or both) to supplement the electrical output of the plant. In this manner, the plant 1104 may made be capable of providing 100% or more of its rated capacity (i.e., 100 MW in this example) at any time even when the wind or sun is insufficient. This is because the power output may be supplemented by the electricity generated by hydrogen.

As can be seen, the hybrid power plant reduces reliance on sometimes unpredictable environmental conditions when generating clean electrical power by allowing natural energy sources to be converted to hydrogen for storage. This is highly beneficial especially where environmental or weather conditions do not match up with consumer demands for electricity. For example, it may be extremely windy at night when demand for electricity is low. By utilizing the hydrogen generation and storage system 1108, the hybrid power plant can store this wind energy as hydrogen for use when it is needed Likewise, it may be extremely sunny, especially in desert climates, when consumers are at work and residential power demand is low. The hybrid power plant can store this solar energy as hydrogen for later use, such as when the wind or sun is insufficient to meet consumer needs for electricity. Since the amount of power generated by the plant 1104 may be substantial, a substantial volume of hydrogen may be generated. Accordingly, a plurality of hydrogen generation and storage subsystems or components there of may be used to efficiently utilize and accommodate the power from the plant 1104 or other power source.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A hydrogen storage system comprising:
one or more electrical power sources configured to generate electrical power from a renewable energy source selected from the group consisting of wind, solar, wave, hydroelectric, and geothermal energy;
an electrolysis tank having a diaphragm, the diaphragm dividing the electrolysis tank into a first section and a second section;
at least one positive electrode in the first section;
at least one negative electrode in the second section;
at least one first conduit extending from an upper portion of the first section to accept oxygen gas from the first section;
at least one second conduit extending from an upper portion of the second section to accept hydrogen gas from the second section;
one or more storage tanks configured to releasably store the hydrogen gas and oxygen gas, the one or more storage tanks connected to the at least one first conduit and the at least one second conduit; and
one or more controllers configured to route electrical power from the one or more electrical power sources to the at least one positive electrode and the at least one negative electrode when the amount of electrical power generated by the one or more electrical power sources exceeds the amount of electrical power that is demanded from the one or more electrical power sources.

2. The hydrogen storage system of claim 1, wherein the one or more controllers are further configured to release hydrogen gas from the one or more storage tanks when the amount of electrical power generated by the one or more electrical power sources is less than the amount of electrical power that is being demanded from the one or more electrical power sources.

3. The hydrogen storage system of claim 1, wherein at least one of the one or more electrical power sources includes a fuel cell generator configured to generate electricity from hydrogen gas, the fuel cell generator connected to at least one of the one or more storage tanks by at least one third conduit.

4. The hydrogen storage system of claim 1 further comprising a hydrogen powered steam turbine configured to generate electricity from burning hydrogen gas, the hydrogen powered steam turbine connected to at least one of the one or more storage tanks by at least one third conduit.

5. The hydrogen storage system of claim 1 further comprising at least one valve connecting the one or more storage tanks to the electrolysis chamber, the at least one valve configured to control the flow rate of the oxygen gas relative to the hydrogen gas from the electrolysis chamber to the one or more storage tanks.

6. The hydrogen storage system of claim 1, wherein the one or more storage tanks comprise a first compartment for storing oxygen and a second compartment for storing hydrogen, the first compartment connected to the at least one first conduit and the second compartment connected to the at least one second conduit.

7. The hydrogen storage system of claim 1, wherein the one or more storage tanks are portable and are removable from the at least one first conduit and the at least one second conduit.

8. A hydrogen storage system comprising:
an electrical power source configured to generate a first amount of electrical power to meet at least some of a demand for a second amount of electrical power;
one or more electrolysis chambers comprising at least one positive electrode and at least one negative electrode, the one or more electrolysis chambers configured to generate hydrogen gas and oxygen gas from water;
one or more electrical conduits connecting the electrical power source to the at least one positive electrode and the at least one negative electrode;
one or more storage tanks configured to store the hydrogen gas and oxygen gas from the one or more electrolysis chambers;
one or more conduits connecting the one or more storage tanks to the one or more electrolysis chambers; and
at least one controller configured to divert electrical power from the electrical power source to the at least one positive electrode and the at least one negative electrode when the first amount of power is greater than the second amount of power, and to release hydrogen gas from the one or more storage tanks when the first amount of power is less than the second amount of power.

9. The hydrogen storage system of claim 8 further comprising a hydrogen powered electrical generator configured to accept hydrogen gas from the one or more storage tanks and to oxidize the hydrogen gas to generate electricity.

10. The hydrogen storage system of claim 8 further comprising one or more compressors configured to compress the hydrogen gas and the oxygen gas in the one or more storage tanks.

11. The hydrogen storage system of claim 8 wherein at least one of the one or more storage tanks are configured to store hydrogen, and at least another of the one or more storage tanks are configured to store oxygen.

12. The hydrogen storage system of claim 8, wherein the one or more storage tanks comprise an outlet port configured to control outflow of the oxygen gas relative to the hydrogen gas to generate a predetermined ratio of hydrogen gas and oxygen gas.

13. The hydrogen storage system of claim 8 further comprising at least one valve connecting the one or more storage tanks to the one or more electrolysis chambers, the at least one valve configured to control the flow rate of the oxygen gas relative to the hydrogen gas from the one or more electrolysis chambers to the one or more storage tanks.

14. The hydrogen storage system of claim 8, wherein the one or more electrical power sources are configured to generate the first amount of electrical power from a renewable energy source selected from the group consisting of wind, hydroelectric, solar, wave, and geothermal energy.

15. A method for generating and storing energy with hydrogen comprising:
generating a first amount of electrical power with a first generator to meet at least some of a demand for a second amount of electrical power;
routing at least some of the first amount of electrical power to an electrolysis chamber if the first amount of electrical power excess the second amount of electrical power;
storing hydrogen generated by the electrolysis chamber in one or more hydrogen storage tanks; and
releasing at least some of the hydrogen from the one or more hydrogen storage tanks if the first amount of electrical power is less than the second amount of electrical power;
generating a third amount of electrical power with a second generator and the hydrogen released from the one or more hydrogen storage tanks, the second generator configured to convert the released hydrogen into electricity.

16. The method of claim 14 further comprising transmitting the first amount of electricity and the third amount of electricity to one or more consumers.

17. The method of claim 14, wherein generating the first amount of electrical power with the first generator comprises converting renewable energy selected from the group consisting of wind, hydroelectric, solar, wave, and geothermal energy into electricity.

18. The method of claim 14 further comprising storing oxygen generated by the electrolysis chamber in one or more oxygen storage tanks.

19. The method of claim 18 further comprising mixing the stored oxygen and stored hydrogen according to a predetermined ratio prior to generating the third amount of electrical power.

20. The method of claim 14 further comprising routing all of the first amount of power to meet the demand for second amount of power if the first amount of power is less than the second amount of power.
